(19) United States
(12) Patent Application Publication
(10) Pub. No.: US 2003/0074759 A1
(43) Pub. Date: Apr. 24, 2003

(54) Paint roller

(76) Inventor: Poh Leong Er, Singapore (SG)

Correspondence Address: LAWRENCE N. GINSBERG, 907 CITRUS PLACE, NEWPORT BEACH, CA, 92660-3227, US

(21) Appl. No.: 10/040,652

(22) Filed: Oct. 19, 2001

(51) Int. Cl. B05C 17/02

(52) U.S. Cl. 15/230.11; 492/13; 492/19

(57) ABSTRACT

A paint roller (10) has a paint applicator (12), two holder mounts and an applicator holder (14). The paint applicator (12) has a cylindrical outer surface (16) and two opposite ends (18a,18b). The two holder mounts, respectively associated with the two opposite ends (18a,18b), each has a base surface (24). A journal (26) protrudes from the base surface (24) in a direction away from the paint applicator (12). The journal (26) has a holder abutment with a planar abutment surface (30) substantially aligned on a common plane. The applicator holder (14) has a handle (40) and a fork (42) having opposite sides (44,46). Each of the opposite sides (44,46) has a journal engagement portion (52,54)

### FIELD OF THE INVENTION

The present invention relates to apparatus for applying fluids over surfaces. In particular, the present invention relates to a paint roller for storing and applying paint.

### BACKGROUND OF THE INVENTION

Paint rollers for applying paint onto surfaces are known. Typically, such paint rollers have paint-absorbing surfaces that are dipped into paint containers and then rolled over surfaces that are to be painted. For example, U.S. Pat. No. 6,098,240, issued to Taylor, describes a roller paint applicator with a cylindrical body and that is secured to an applicator holder for rotation around a spindle using an end cap. However, rotation of the paint roller described in U.S. Pat. No. 6,098,240 is a problem when excessive force is applied to the applicator holder. Such a force can dent the paint applicator towards the spindle and undesirably restrict rotation of the spindle.

Another type of paint roller is described in U.S. Pat. No. 6,098,240 in which internal storage or container space is provided to store paint. The paint is then transferred from the internal storage or container space through permeable members onto surfaces. An example of such an improvement to paint rollers is disclosed in U.S. Pat. No. 3,588,264, issued to Mallindine and that describes a container-type paint roller with a roller assembly. The roller assembly is rolled along a surface by means of a forked handle that is coupled to journals of end-closure members disposed at opposite ends of the roller assembly.

However, rotation of the roller assembly of U.S. Pat. No. 3,588,26 can be a problem as the end-closure members contacts the entire surface of sides of the forked handle. Consequently, frictional resistance between the sides and the end-closure members impedes the rotation of the roller assembly to some extent. Furthermore, any unevenness of the surface of the end closure members also impedes the rotation. Such unevenness is difficult to avoid or eliminate in mass production of the end-closure members or the forked handle.

Therefore, a need clearly exists for a container-type paint roller that enables easier rotation of a paint applicator by reducing frictional resistance between rotating elements. Such a container-type paint roller should have covers that secure tightly to the paint applicator or an applicator holder without, or at least alleviating, undesired dislodging of such covers during use.

### BRIEF SUMMARY OF THE INVENTION

The present invention seeks to provide a paint roller having a paint applicator and two holder mounts respectively associated with two opposite ends of the paint applicator.

Accordingly, in one aspect, the present invention provides a paint roller comprising:

a paint applicator having a cylindrical outer surface and two opposite ends; and

two holder mounts, respectively associated with the two opposite ends, each of the holder mounts having a base surface and comprising:

a journal, protruding from the base surface in a direction away from the paint applicator, the journal comprising at least one holder abutment, each of the at least one holder abutment having a planar abutment surface substantially aligned on a common plane.

In another aspect, the present invention provides a paint roller comprising:

a paint applicator having a cylindrical outer surface and two opposite ends;

two holder mounts, respectively associated with the two opposite ends, each of the holder mounts having a base surface and comprising:

a journal, protruding from the base surface in a direction away from the paint applicator, the journal comprising at least one holder abutment, each of the at least one holder abutment having a planar abutment surface substantially aligned on a common plane; and

an applicator holder having:

a handle; and

a fork having opposite sides, each of the opposite sides having a journal engagement portion.

### BRIEF DESCRIPTION OF THE DRAWINGS

A preferred embodiment and an alternate embodiment of the present invention are described, by way of example, with reference to the drawings of which:

FIG. 1 is a perspective view of a paint roller having a paint applicator and an applicator holder in accordance with the preferred embodiment of the invention;

FIG. 2 is an exploded view of the paint roller of FIG. 1;

FIG. 3 is a side view of a holder mount associated with one end of the paint applicator of FIG. 1;

FIG. 4 is a side view of a cover for one end of the paint applicator of FIG. 1;

FIG. 5 is a plan view of a holder mount in accordance with the alternate embodiment of the invention; and

FIG. 6 is a side view of an end portion of the holder mount of FIG. 5.

### DETAILED DESCRIPTION OF THE DRAWINGS

A paint roller having a paint applicator and two holder mounts for coupling to an applicator holder in accordance with a preferred embodiment and an alternate embodiment of the invention are described. In the following description, details are provided to describe these embodiments. However, it shall be apparent to one skilled in the art that the invention may be practiced without such details. Some of these details may not be described at length so as not to obscure the invention.

There are many advantages of the embodiments of the invention. One advantage of the embodiments is that frictional resistance between abutting surfaces of the holder mounts and the applicator holder is reduced. Consequently, the embodiments enable a more effective rotation of the paint applicator when held by the applicator holder during use of the paint roller.

Another advantage of the embodiments of the invention is that ridges, formed on an inner wall of a channel of one of the holder mounts and on a cover, enable a tight capping of the holder mount. Consequently, paint is stored more securely within the paint applicator without, or at least alleviating, accidental spills due to dislodging of the cover during use of the paint roller.

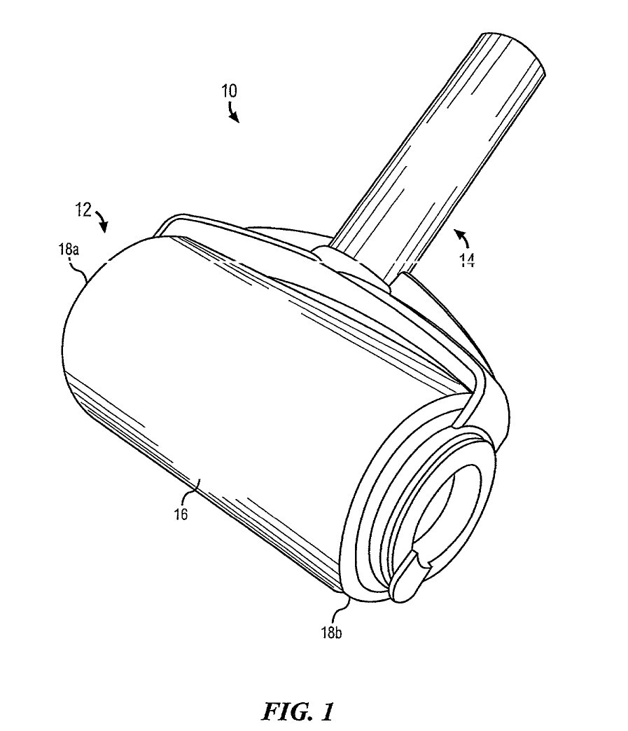

Referring now to FIG. 1, a perspective view of a paint roller 10 in accordance with the preferred embodiment of the invention is illustrated. The paint roller 10 comprises a paint applicator 12 and an applicator holder 14 for holding the paint applicator 12. The paint applicator 12 has a cylindrical outer surface 16 and two opposite ends 18a,18b. The paint applicator 12 is preferably made of a paint absorbent material such as, for example, foam or sponge.

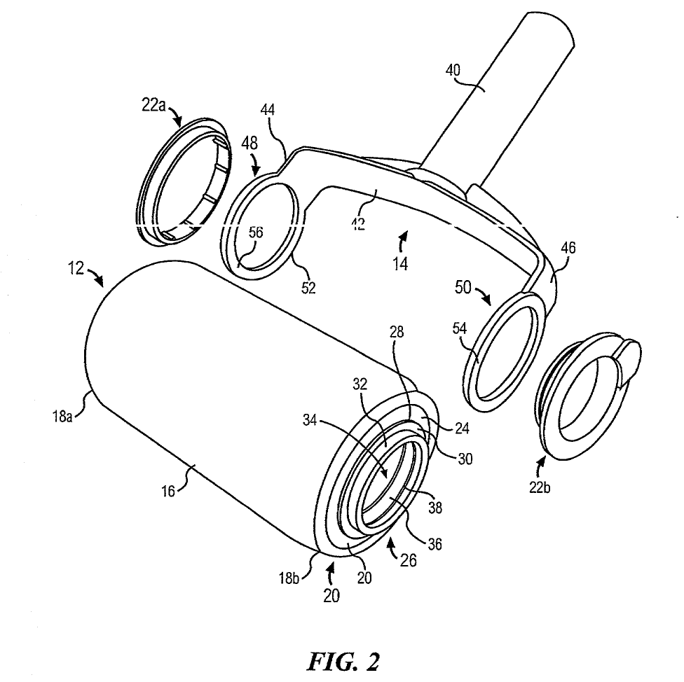

The paint roller 10 further comprises two holder mounts, respectively associated with the two opposite ends 18a,18b. A holder mount 20, associated with the opposite end 18b, is shown in the exploded view of the paint roller 10 in FIG. 2. Also shown in FIG. 2 are two covers 22a,22b for capping the two holder mounts.

The holder mount 20 has a base surface 24 and comprises a journal 26 that protrudes from the base surface 24 in a direction away from the paint applicator 12. The journal 26 comprises a holder abutment 28 having a planar abutment surface 30. The journal 26 further comprises a cylindrical protrusion 32 forming a channel 34 through which paint is channeled for storage within the paint applicator 12. In the preferred embodiment of the invention, the holder abutment 28 forms a ring surrounding the cylindrical protrusion 32. An inner wall 36 of the channel 34 has a circumferential ridge 38. For the journal 26, the planar abutment surface 30 has a total area that is smaller than an axial cross-section of the holder mount 20.

The applicator holder 14 has a handle 40 and a fork 42 having opposite sides 44,46. Each of the opposite sides 44,46 has, respectively, a journal engagement portion 48,50. Each of the journal engagement portions 48,50 comprises, respectively, a loop 52,54. The loop 54 couples to the cylindrical protrusion 32, and the loop 52 couples to a cylindrical protrusion (not shown) at the opposite end 18a, to enable rotation of the paint applicator 12 during use.

The loop 54 has a mount abutment surface (not shown) with an area larger than the total area of the planar abutment surface 30. The mount abutment surface for the loop 54 is similar to a mount abutment surface 56 for the loop 52. Hence, contact area between the planar abutment surface 30 and the mount abutment surface of the loop 54 is at most the area of the planar abutment surface 30. Consequently, only frictional resistance of respective contact areas, and not the entire area of the mount abutment surfaces of the loops 52,54, impedes rotation of the paint applicator 12 when held by the applicator holder 14.

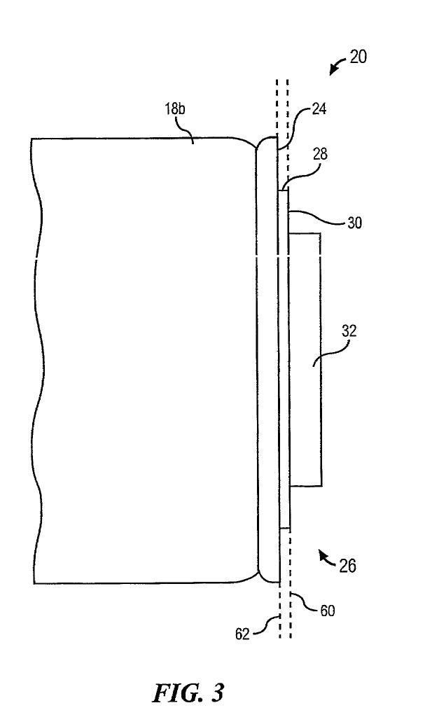

FIG. 3 is a side view of the holder mount 20 showing position of the holder abutment 28 relative to the base surface 24 and the journal 26. The planar abutment surface 30 is substantially aligned on a common plane 60. In the preferred embodiment, the common plane 60 is planarly parallel to a base plane 62 of the base surface 24 and spaced apart by the thickness of the holder abutment 28.

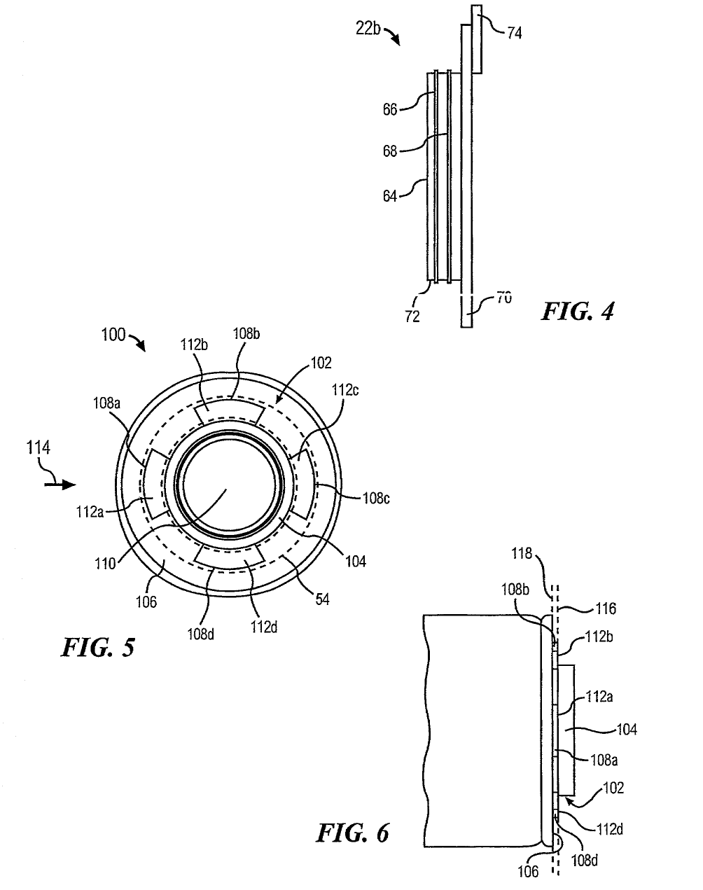

Referring now to FIG. 4, a side view of the cover 22b for capping the holder mount 20 is illustrated. The cover 22b comprises a cylindrical portion 64 having two perimeter ridges 66,68 and a flange 70. The flange 70 extends beyond a perimeter 72 of the cylindrical portion 64. The cover 22b further comprises a flange extension 74 to enable removal of the cover 22b to thereby replenish paint within, or empty paint from, the paint applicator 12.

The two perimeter ridges 66,68 are engageable with the circumferential ridge 38 of the inner wall 36 to enable a tight capping of the holder mount 20 by the cover 22b. Specifically, the diameter of the cylindrical portion 64 is made slightly larger than the diameter of the channel 34 to provide a secure fitting. This secure fitting is enhanced by engagement between the perimeter ridges 66,68 and the circumferential ridge 38 when capping the holder mount 20. Hence, a force applied to cap the cover 22b onto the holder mount 20 has to overcome abutting of the cylindrical portion 64 and the channel 34 as well as abutting of the perimeter ridges 66,68 and the circumferential ridge 38.

FIG. 5 is plan view of a holder mount 100 in accordance with the alternate embodiment of the invention. In the holder mount 100, a journal 102 comprises a cylindrical protrusion 104 extending from a base surface 106 of the holder mount 100 and at least one holder abutment 108. The cylindrical protrusion 104 forms a channel 110 through which paint is channeled for storage within the paint applicator 12. FIG. 5 also shows the area of the mount abutment surface of the loop 54 in dotted outline.

The holder abutment 108 corresponds to a plurality of arc-shaped members. FIG. 5 shows four arc-shaped members 108a,108b,108c,108d disposed around the cylindrical protrusion 104. Each of the four arc-shaped members 108a,108b,108c,108d has a planar abutment surface 112a,112b,112c,112d. As illustrated, the mount abutment surface of the loop 54 has an area larger than total area of the planar abutment surfaces 112a,112b,112c,112d. Also, the total area of the planar abutment surfaces 112a,112b,112c,112d is smaller than an axial cross-section of the holder mount 100.

In FIG. 6, a side view of an end portion of the holder mount 100 from a direction indicated by an arrow 114 shows the planar abutment surfaces 112a,112b,112d of, respectively, the arc-shaped members 108a,108b,108d. The planar abutment surfaces 112a,112b,112d are substantially aligned to each other on a common plane 116. Although not shown, the planar abutment surface 112c is also similarly aligned. In this alternate embodiment, the common plane 116 is planarly parallel to a base plane 118 of the base surface 106 and spaced apart by the thickness of the four arc-shaped members 108a,108b,108c,108d.

While the present invention has been described in detail for a preferred embodiment and an alternate embodiment with reference to FIGS. 1 to 6, it should be understood that FIGS. 1 to 6 are illustrative of the embodiments without limiting the invention. Accordingly, persons skilled in the art can make various modifications and improvements without departing from the spirit and the scope of the present invention.

What is claimed is:

1. A paint roller comprising:
a paint applicator having a cylindrical outer surface and two opposite ends; and
two holder mounts, respectively associated with said two opposite ends, each of said holder mounts having a base surface and comprising:
a journal, protruding from said base surface in a direction away from said paint applicator, said journal comprising at least one holder abutment, each of said at least one holder abutment having a planar abutment surface substantially aligned on a common plane.

2. The paint roller as claimed in claim 1, wherein total area of said planar abutment surface for each of said journal is smaller than an axial cross-section of each of said holder mounts.

3. The paint roller as claimed in claim 1, wherein said journal further comprises a cylindrical protrusion.

4. The paint roller as claimed in claim 3, wherein said at least one holder abutment forms a ring surrounding said cylindrical protrusion.

5. The paint roller as claimed in claim 3, wherein said at least one holder abutment forms a plurality of arc-shaped members disposed around said cylindrical protrusion.

6. The paint roller as claimed in claim 3, wherein said cylindrical protrusion forms a channel with an inner wall having at least one circumferential ridge.

7. The paint roller as claimed in claim 1, and further comprising an applicator holder having:
a handle; and
a fork having opposite sides, each of said opposite sides having a journal engagement portion.

8. The paint roller as claimed in claim 7, wherein said journal engagement portion comprises a loop for coupling to said journal.

9. The paint roller as claimed in claim 8, wherein said loop comprises a mount abutment surface, said mount abutment surface having an area larger than total area of said planar abutment surface for each of said journal.

10. The paint roller as claimed in claim 9, wherein said area of said mount abutment surface is smaller than an axial cross-section of each of said holder mounts.

11. The paint roller as claimed in claim 7, and further comprising a cover for capping at least one of said holder mounts.

12. The paint roller as claimed in claim 11, wherein said cover comprises a cylindrical portion having at least one perimeter ridge.

13. A paint roller comprising:
a paint applicator having a cylindrical outer surface and two opposite ends;
two holder mounts, respectively associated with said two opposite ends, each of said holder mounts having a base surface and comprising:
a journal, protruding from said base surface in a direction away from said paint applicator, said journal comprising at least one holder abutment, each of said at least one holder abutment having a planar abutment surface substantially aligned on a common plane; and
an applicator holder having:
a handle; and
a fork having opposite sides, each of said opposite sides having a journal engagement portion.

14. The paint roller as claimed in claim 13, wherein total area of said planar abutment surface for each of said journal is smaller than an axial cross-section of each of said holder mounts.

15. The paint roller as claimed in claim 13, wherein said journal further comprises a cylindrical protrusion.

16. The paint roller as claimed in claim 15, wherein said at least one holder abutment forms a ring surrounding said cylindrical protrusion.

17. The paint roller as claimed in claim 15, wherein said at least one holder abutment forms a plurality of arc-shaped members disposed around said cylindrical protrusion.

18. The paint roller as claimed in claim 15, wherein said cylindrical protrusion forms a channel with an inner wall having at least one circumferential ridge.

19. The paint roller as claimed in claim 13, wherein said journal engagement portion comprises a loop for coupling to said journal.

20. The paint roller as claimed in claim 19, wherein said loop comprises a mount abutment surface, said mount abutment surface having an area larger than total area of said planar abutment surface for each of said journal.

21. The paint roller as claimed in claim 20, wherein said area of said mount abutment surface is smaller than an axial cross-section of each of said holder mounts.

22. The paint roller as claimed in claim 13, and further comprising a cover for capping at least one of said holder mounts.

23. The paint roller as claimed in claim 22, wherein said cover comprises a cylindrical portion having at least one perimeter ridge.
